(19) United States
(12) Patent Application Publication
(10) Pub. No.: US 2026/0245480 A1
(43) Pub. Date: Aug. 20, 2026

(54) MODEL BOX FOR SIMULATING COSEISMIC STICK-SLIP DISLOCATION, AND USE METHOD THEREOF

(71) Applicant: Jianghan University, Wuhan (CN)

(72) Inventors: Jie WANG, Wuhan (CN); Longjun XU, Wuhan (CN); Hao TIAN, Wuhan (CN); Heng ZHANG, Wuhan (CN); Shibin LIN, Wuhan (CN); Guochen ZHAO, Wuhan (CN); Xingji ZHU, Wuhan (CN); Hong WU, Wuhan (CN)

(73) Assignee: Jianghan University, Wuhan (CN)

(21) Appl. No.: 19/641,879

(22) Filed: Apr. 8, 2026

(30) Foreign Application Priority Data
May 15, 2025 (CN) 202510628678.2

(51) Int. Cl. G09B 23/10

(52) U.S. Cl. CPC G09B 23/10

(57) ABSTRACT

A model box for simulating a coseismic stick-slip dislocation includes: a loading device including two seismic fault testing device-loading platforms with an interval space formed between the two platforms; a vertical simulation device including a plurality of vertical stacking frames, where an end of each of the plurality of vertical stacking frames is vertically arranged within the interval space; and a horizontal simulation device including two sets of horizontal stacking frames and two sets of stacking blocks, where the two sets of horizontal stacking frames are symmetrically arranged on the two seismic fault testing device-loading platforms, and each of the two sets of stacking blocks is arranged adjacent to the two sets of horizontal stacking frames. The model box is capable of simulating a coseismic stick-slip dislocation across a fault zone and acquiring three-dimensional deformation characteristics of an overlying soil layer across the fault zone.

### CROSS-REFERENCE TO RELATED APPLICATIONS

This application claims priority to Chinese Patent Application No. 202510628678.2 with a filing date of May 15, 2025. The content of the aforementioned application, including any intervening amendments thereto, is incorporated herein by reference.

### TECHNICAL FIELD

The present disclosure relates to the field of testing structural dynamic responses under cross-fault zone ground motion, and particularly relates to a model box for simulating a coseismic stick-slip dislocation, and a use method thereof.

### BACKGROUND

With the development of geotechnical and underground engineering, an increasing number of large-scale underground projects inevitably need to be constructed in fault zones. For a project across a concealed fault, a combined action of relative displacement resulting from the ground failure caused by fault dislocation and vibration damage resulting from the intense ground motion of a fault needs to be considered. The seismic hazard issue of shield tunnels crossing concealed faults is one of the most complex and challenging topics within the broad field of research on the seismic resistance of tunnels. However, relevant studies lag significantly behind engineering demands. Therefore, there is an urgent need to study and understand response behaviors and disaster mechanisms of shield tunnels crossing concealed faults under strong earthquake-dislocation coupled effects. This aims to clarify misconceptions and provide a scientific basis and technical support for the seismic disaster prevention and mitigation efforts on shield tunnels across concealed faults as major lifeline projects in China.

Physical model testing serves as an effective approach for studying seismic hazards in engineering projects across concealed faults. A model box used in physical model testing must be capable of reasonably simulating both vertical dislocation deformation and horizontal shaking deformation of an overlying soil layer across a fault zone. The current research on projects across faults or earthquake effects typically employs a stacked-frame box arranged vertically to simulate vertical dislocation deformation of a soil layer of a fault zone or a stacked-frame box arranged horizontally to simulate horizontal shaking deformation of an overlying soil layer across a fault. This box design can only simulate unidirectional soil layer deformation, and cannot effectively replicate the three-dimensional deformation characteristics of an overlying soil layer across a fault zone under a vertical dislocation-horizontal shaking coupled effect during a coseismic stick-slip dislocation.

Therefore, how to design a model box for simulating a coseismic stick-slip dislocation to effectively replicate the three-dimensional deformation characteristics of an overlying soil layer across a fault zone under a vertical dislocation-horizontal shaking coupled effect is a technical challenge urgently to be addressed by those skilled in the art.

### SUMMARY OF PRESENT INVENTION

In view of the problems in the prior art, the technical problem to be addressed by the present disclosure is to provide a model box for simulating a coseismic stick-slip dislocation. This model box can effectively replicate the three-dimensional deformation characteristics of an overlying soil layer across a fault zone under a vertical dislocation-horizontal shaking coupled effect, which is a technical challenge urgently to be addressed by those skilled in the art.

To achieve the above objective, the present disclosure provides a model box for simulating a coseismic stick-slip dislocation, including: a loading device including two seismic fault testing device-loading platforms, where the two seismic fault testing device-loading platforms are spaced apart and symmetrically arranged on a horizontal plane, and an interval space is formed between the two seismic fault testing device-loading platforms; a vertical simulation device including a plurality of vertical stacking frames, where each of the plurality of vertical stacking frames is in a rectangular frame structure, any adjacent two of the plurality of vertical stacking frames are arranged in contact with each other, and an end of each of the plurality of vertical stacking frames is vertically arranged within the interval space; and a horizontal simulation device including two sets of horizontal stacking frames and two sets of stacking blocks, where each of the two sets of horizontal stacking frames is in an open rectangular frame structure, the two sets of horizontal stacking frames are symmetrically arranged on the two seismic fault testing device-loading platforms with the interval space as an axis of symmetry, and the two sets of horizontal stacking frames are arranged at two sides of the plurality of vertical stacking frames, respectively; each of the two sets of stacking blocks is arranged adjacent to the two sets of horizontal stacking frames, and each of the two sets of stacking blocks is arranged between openings of the two sets of horizontal stacking frames; an opening of each of the two sets of horizontal stacking frames has two open ends; and an end of each of the two sets of stacking blocks abuts against one open end of an adjacent one of the twos set of horizontal stacking frames, and another end of the one of the two sets of stacking blocks abuts against one open end of another adjacent one of the sets of horizontal stacking frames.

In a first aspect, the loading device further includes: a plurality of guide rails, where the plurality of guide rails are arranged within the interval space, the plurality of guide rails are distributed in one-to-one correspondence with the plurality of vertical stacking frames, and an end of each of the plurality of vertical stacking frames is arranged on a corresponding one of the plurality of guide rails; and a plurality of sets of first hydraulic jacks, where the plurality of sets of first hydraulic jacks are distributed in one-to-one correspondence with the plurality of guide rails; and each set of the plurality of sets of first hydraulic jacks includes a plurality of first hydraulic jacks, and the plurality of first hydraulic jacks in each set are evenly spaced apart in a direction of a corresponding vertical stacking frame.

In the first aspect, each set of the two sets of horizontal stacking frames includes a plurality of horizontal stacking frames; each of the plurality of horizontal stacking frames is in an open rectangular frame structure; and the plurality of horizontal stacking frames are arranged in a stacked manner, and a first neoprene rubber pad adapted to any one of the horizontal stacking frames is provided between any two adjacent horizontal stacking frames.

In the first aspect, the horizontal simulation device further includes two sets of fixators; the two sets of fixators are distributed in one-to-one correspondence with the two sets of horizontal stacking frames, and each set of the two sets of fixators is arranged at an end of the corresponding set of horizontal stacking frames that is away from the interval space; each set of the two sets of fixators includes two fixators, and the two fixators are spaced apart and arranged at the end of the corresponding set of horizontal stacking frames; each fixator is in a columnar structure, and an end of each fixator is fixed to the corresponding seismic fault testing device-loading platform; each fixator is provided with a plurality of smooth rails in an axial direction of the fixator; and the plurality of smooth rails are distributed in one-to-one correspondence with the plurality of horizontal stacking frames of a corresponding set of horizontal stacking frames, and each of the plurality of smooth rails abuts against a corresponding horizontal stacking frame and the corresponding horizontal stacking frame is capable of sliding smoothly.

In the first aspect, each set of the two sets of stacking blocks includes a plurality of groups of first stacking blocks and two groups of second stacking blocks; the plurality of groups of first stacking blocks are arranged between the two groups of second stacking blocks; the plurality of groups of first stacking blocks are distributed in one-to-one correspondence with the plurality of vertical stacking frames; each group of the plurality of groups of first stacking blocks includes a plurality of first stacking blocks that are adjacently stacked; a second neoprene rubber pad adapted to any first stacking block is provided between any two adjacent first stacking blocks; and widths of each first stacking block and each second stacking block in a vertical direction are the same as a width of each horizontal stacking frame in the vertical direction, and widths of each first stacking block and each second stacking block in a horizontal direction are the same as a width of each vertical stacking frame in the horizontal direction.

In the first aspect, each group of the two groups of second stacking blocks is distributed in one-to-one correspondence with each set of the two sets of horizontal stacking frames; each group of the two groups of second stacking blocks includes a plurality of second stacking blocks that are adjacently stacked; second stacking blocks that are located at a same side and are adjacent to corresponding horizontal stacking frames respectively abut against open ends of the corresponding horizontal stacking frames; a third neoprene rubber pad adapted to any second stacking block is provided between any two adjacent second stacking blocks; and a fourth neoprene rubber pad adapted to any second stacking block is provided between any adjacent second stacking block and horizontal stacking frame.

In the first aspect, the vertical simulation device further includes: two steel support frames, where each of the two steel support frames is in an open rectangular frame structure; the two steel support frames are fixed to the two seismic fault testing device-loading platforms, respectively, and the two steel support frames are arranged at two sides of the plurality of vertical stacking frames, respectively; an edge of one of the two steel support frames abuts against an adjacent vertical stacking frame at a side, and an edge of the other one of the two steel support frames abuts against an adjacent vertical stacking frame at another side; and a fifth neoprene rubber pad adapted to any vertical stacking frame is provided between any two adjacent vertical stacking frames; and the vertical simulation device further includes two sets of second hydraulic jacks, where the two sets of second hydraulic jacks are symmetrically arranged along a central axis of symmetry of the two sets of horizontal stacking frames; each set of the two sets of second hydraulic jacks includes two groups of second hydraulic jacks, and the two groups of second hydraulic jacks are distributed in one-to-one correspondence with the two sets of horizontal stacking frames; each group of the two groups of second hydraulic jacks includes a plurality of second hydraulic jacks, and the plurality of second hydraulic jacks in each group are distributed in one-to-one correspondence with a plurality of horizontal stacking frames in a corresponding set of horizontal stacking frames; two open ends of each horizontal stacking frame in each set are located between two vertical inner side surfaces of an adjacent steel support frame; and an end of each second hydraulic jack is in contact with a corresponding horizontal stacking frame, and another end of the second hydraulic jack is vertically fixed within two vertical inner side surfaces of an adjacent steel support frame.

In the first aspect, the vertical simulation device further includes two sets of third hydraulic jacks; the two sets of third hydraulic jacks are symmetrically arranged along the central axis of symmetry of the two sets of horizontal stacking frames; each set of the two sets of third hydraulic jacks includes a plurality of groups of third hydraulic jacks, and the plurality of groups of third hydraulic jacks are distributed in one-to-one correspondence with the plurality of vertical stacking frames; each group of the plurality of groups of third hydraulic jacks includes a plurality of third hydraulic jacks; the plurality of third hydraulic jacks in each group are evenly spaced along a vertical inner side surface of a corresponding vertical stacking frame; an end of each third hydraulic jack is fixedly connected to a corresponding vertical stacking frame; each group of third hydraulic jacks is distributed in one-to-one correspondence with each group of first stacking blocks; and another end of each third hydraulic jack abuts against a corresponding first stacking block.

In the first aspect, the vertical simulation device further includes two sets of fourth hydraulic jacks; the two sets of fourth hydraulic jacks are symmetrically arranged along the central axis of symmetry of the two sets of horizontal stacking frames; each set of the two sets of fourth hydraulic jacks includes two groups of fourth hydraulic jacks, and the two groups of fourth hydraulic jacks are distributed in one-to-one correspondence with the two steel support frames; each group of the two groups of fourth hydraulic jacks includes a plurality of fourth hydraulic jacks; the plurality of fourth hydraulic jacks in each group are evenly spaced along a vertical inner side surface of a corresponding steel support frame; an end of each fourth hydraulic jack is fixedly connected to a corresponding steel support frame; each group of fourth hydraulic jacks is distributed in one-to-one correspondence with each group of second stacking blocks; and another end of each fourth hydraulic jack abuts against a corresponding second stacking block.

The present disclosure also provides a use method of the model box described above, which includes: mounting the model box; filling a model soil layer inside the model box, such that a jacking force of each second hydraulic jack is equal to a geostatic resultant stress at a burial depth of the model soil layer corresponding to a horizontal stacking frame, a jacking force of each third hydraulic jack is equal to a geostatic resultant stress at a burial depth of the model soil layer corresponding to a first stacking block, a jacking force of each fourth hydraulic jack is equal to a geostatic resultant force at a burial depth of the model soil layer corresponding to a second stacking block, and a combined jacking force of each first hydraulic jack is equal to a gravity of the model soil layer corresponding to a depth where the model soil layer locates; and simulating the coseismic stick-slip dislocation with the two seismic fault testing device-loading platforms, monitoring displacement change data of each vertical stacking frame, each first stacking block, each second stacking block, and each horizontal stacking frame, and generating an internal deformation pattern of the model soil layer during a simulated coseismic stick-slip dislocation process based on the displacement change data.

Beneficial effects:

The model box for simulating a coseismic stick-slip dislocation provided in the present disclosure mainly includes a loading device, a vertical simulation device, and a horizontal simulation device. The loading device includes seismic fault testing device-loading platforms, guide rails, and first hydraulic jacks. The seismic fault testing device-loading platforms are primarily configured to simulate a coseismic stick-slip dislocation. An interval space formed between the seismic fault testing device-loading platforms serves as the main dislocation zone. The vertical simulation device includes vertical stacking frames and steel support frames. The vertical stacking frames are supported by the guide rails and can slide on the guide rails during a dislocation test. The guide rails can not only support the vertical stacking frames but also reduce the friction between vertical stacking frames, thereby enhancing the accuracy of testing. The steel support frames are fixed to the seismic fault testing device-loading platforms and are located at two sides of the vertical stacking frames. The steel support frames are configured to fix the vertical stacking frames in an X-direction, thereby preventing the vertical stacking frames from moving in the X-direction during a dislocation test to affect the dislocation test. The horizontal simulation device mainly includes horizontal stacking frames and stacking blocks. The horizontal stacking frames are arranged in the X-direction. The horizontal stacking frames are located at two sides of the stacking blocks, and are in contact with the stacking blocks to form a rectangular stacked ring. Two open ends of each

horizontal stacking frame, namely, contact ends of the horizontal stacking frame with a stacking block, are located between two side supports of the steel support frames. The vertical simulation device further includes second hydraulic jacks, third hydraulic jacks, and fourth hydraulic jacks. The stacking blocks include first stacking blocks and second stacking blocks. The second stacking blocks are located at two sides of the first stacking blocks. Positions of the first stacking blocks correspond to positions of the vertical stacking frames. Positions of the second stacking blocks correspond to positions of the steel support frames. The second hydraulic jacks are connected to the steel support frames and the horizontal stacking frames. The third hydraulic jacks are connected to the first stacking blocks and the vertical stacking frames. The fourth hydraulic jacks are connected to the second stacking blocks and the steel support frames. The second hydraulic jacks are located at a side of the fourth hydraulic jacks. The second hydraulic jacks, the third hydraulic jacks, and the fourth hydraulic jacks are all configured to simulate lateral boundary conditions of a soil during a dislocation test, avoiding interference with the dislocation test. Jacking forces of a second hydraulic jack, a third hydraulic jack, and a fourth hydraulic jack are set to equal geostatic resultant stresses at depths of a soil layer corresponding to a horizontal stacking frame, a first stacking block, and a second stacking block, respectively, thereby restricting a lateral displacement of a soil. Before testing, a soil is filled in the model box for simulating a coseismic stick-slip dislocation provided in the present disclosure. During a dislocation process, the vertical stacking frames slide in a Z-Y plane, such that the first stacking blocks, the second stacking blocks, and the horizontal stacking frames slide in the Z-Y plane. Through displacement variations of the vertical stacking frames, the second stacking blocks, and the horizontal stacking frames in a Y-direction, the internal deformation of a soil layer can be revealed. In summary, the model box for simulating a coseismic stick-slip dislocation in the present disclosure can be used to simulate a coseismic stick-slip dislocation across a fault zone, namely, a vertical dislocation-horizontal shaking coupled simulation, and acquire the three-dimensional deformation characteristics of an overlying soil layer across the fault zone.

### BRIEF DESCRIPTION OF THE DRAWINGS

To describe the technical solutions in the embodiments of the specification or in the prior art clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of an overall structure of the model box for simulating a coseismic stick-slip dislocation in the present disclosure;

FIG. 2 is a schematic cross-sectional view of the model box for simulating a coseismic stick-slip dislocation in the present disclosure;

FIG. 3 is a schematic top view of the model box for simulating a coseismic stick-slip dislocation in the present disclosure; and

FIG. 4 is a schematic diagram showing a fixator.

Reference numerals:

1. loading device; 11. seismic fault testing device-loading platform; 12. guide rail; 13. first hydraulic jack;

2. vertical simulation device; 21. vertical stacking frame; 22. steel support frame; 23. second hydraulic jack; 24. third hydraulic jack; 25. fourth hydraulic jack;

3. horizontal simulation device; 31. horizontal stacking frame; 32. stacking block; 321. first stacking block; 322. second stacking block; 33. fixator; 331. smooth rail; and

001. interval space.

### DETAILED DESCRIPTION OF THE EMBODIMENTS

The technical solutions in the embodiments of the specification are clearly and completely described below with reference to the accompanying drawings in the embodiments of the specification. Apparently, the embodiments are merely some rather than all of the embodiments of the specification. All other embodiments obtained by those of ordinary skill in the art based on the embodiments of the specification shall fall within the protection scope of the present disclosure.

Embodiment 1

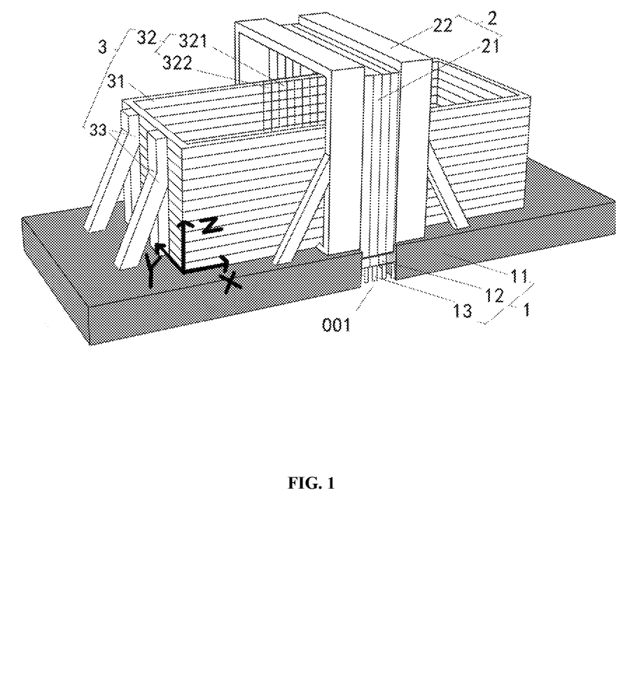

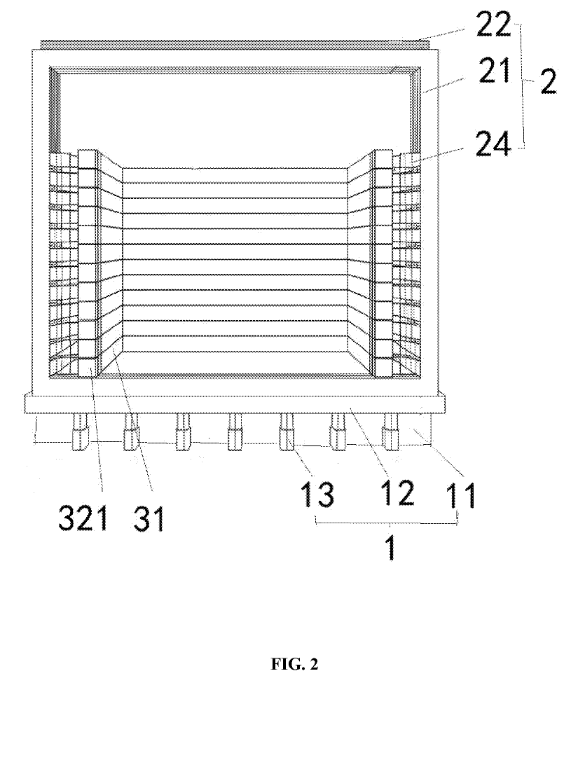

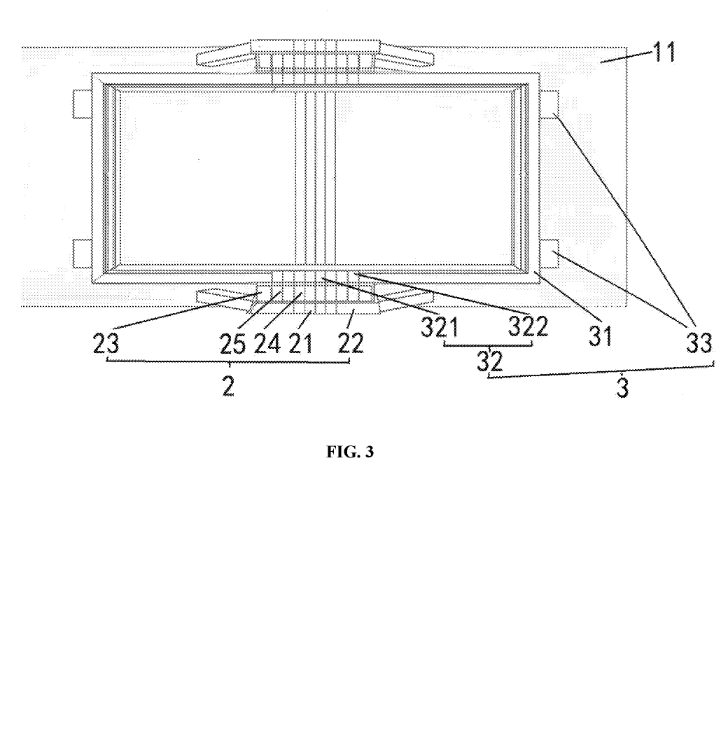

As shown in FIG. 1 to FIG. 3, Embodiment 1 provides a model box for simulating a coseismic stick-slip dislocation, including: a loading device 1 including two seismic fault testing device-loading platforms 11, a vertical simulation device 2 including a plurality of vertical stacking frames 21, and a horizontal simulation device 3 including two sets of horizontal stacking frames 31 and two sets of stacking blocks 32. The two seismic fault testing device-loading platforms 11 are spaced apart and symmetrically arranged on a horizontal plane. An interval space 001 is formed between the two seismic fault testing device-loading platforms 11. Each of the plurality of vertical stacking frames 21 is in a rectangular frame structure. Any two of the plurality of vertical stacking frames 21 are arranged in contact with each other. An end of each of the plurality of vertical stacking frames 21 is vertically arranged within the interval space 001. Each of the two sets of horizontal stacking frames 31 is in an open rectangular frame structure. The two sets of horizontal stacking frames 31 are symmetrically arranged on the two seismic fault testing device-loading platforms 11 with the interval space 001 as an axis of symmetry. The two sets of horizontal stacking frames 31 are arranged at two sides of the plurality of vertical stacking frames 21, respectively. Each of the two sets of stacking blocks 32 is arranged adjacent to the two sets of horizontal stacking frames 31. Each of the two sets of stacking blocks 32 is arranged between openings of the two sets of horizontal stacking frames 31. An opening of each of the two sets of horizontal stacking frames 31 has two open ends. An end of each of the two sets of stacking blocks 32 abuts against one open end of one adjacent set of horizontal stacking frames 31, and another end of the set of stacking blocks 32 abuts against one open end of the other adjacent set of horizontal stacking frames 31.

The model box for simulating a coseismic stick-slip dislocation provided in the present disclosure mainly includes a loading device, a vertical simulation device, and a horizontal simulation device. The loading device includes seismic fault testing device-loading platforms, guide rails, and first hydraulic jacks. The seismic fault testing device-loading platforms are primarily configured to simulate a coseismic stick-slip dislocation. An interval space formed between the seismic fault testing

device-loading platforms serves as the main dislocation zone. The vertical simulation device includes vertical stacking frames and steel support frames. The vertical stacking frames are supported by the guide rails and can slide on the guide rails during a dislocation test. The guide rails can not only support the vertical stacking frames but also reduce the friction between vertical stacking frames, thereby enhancing the accuracy of testing. The steel support frames are fixed to the seismic fault testing device-loading platforms and are located at two sides of the vertical stacking frames. The steel support frames are configured to fix the vertical stacking frames in an X-direction, thereby preventing the vertical stacking frames from moving in the X-direction during a dislocation test to affect the dislocation test. The horizontal simulation device mainly includes horizontal stacking frames and stacking blocks. The horizontal stacking frames are arranged in the X-direction. The horizontal stacking frames are located at two sides of the stacking blocks, and are in contact with the stacking blocks to form a rectangular stacked ring. Two open ends of each horizontal stacking frame, namely, contact ends of the horizontal stacking frame with a stacking block, are located between two side supports of the steel support frames. The vertical simulation device further includes second hydraulic jacks, third hydraulic jacks, and fourth hydraulic jacks. The stacking blocks include first stacking blocks and second stacking blocks. The second stacking blocks are located at two sides of the first stacking blocks. Positions of the first stacking blocks correspond to positions of the vertical stacking frames. Positions of the second stacking blocks correspond to positions of the steel support frames. The second hydraulic jacks are connected to the steel support frames and the horizontal stacking frames. The third hydraulic jacks are connected to the first stacking blocks and the vertical stacking frames. The fourth hydraulic jacks are connected to the second stacking blocks and the steel support frames. The second hydraulic jacks are located at a side of the fourth hydraulic jacks. The second hydraulic jacks, the third hydraulic jacks, and the fourth hydraulic jacks are all configured to simulate lateral boundary conditions of a soil during a dislocation test, avoiding interference with the dislocation test. Jacking forces of a second hydraulic jack, a third hydraulic jack, and a fourth hydraulic jack are set to equal geostatic resultant stresses at depths of a soil layer corresponding to a horizontal

stacking frame, a first stacking block, and a second stacking block, respectively, thereby restricting a lateral displacement of a soil. Before testing, a soil is filled in the model box for simulating a coseismic stick-slip dislocation provided in the present disclosure. During a dislocation process, the vertical stacking frames slide in a Z-Y plane, such that the first stacking blocks, the second stacking blocks, and the horizontal stacking frames slide in the Z-Y plane. Through displacement variations of the vertical stacking frames, the second stacking blocks, and the horizontal stacking frames in a Y-direction, the internal deformation of a soil layer can be revealed. In summary, the model box for simulating a coseismic stick-slip dislocation in the present disclosure can be used to simulate a coseismic stick-slip dislocation across a fault zone, namely, a vertical dislocation-horizontal shaking coupled simulation, and acquire the three-dimensional deformation characteristics of an overlying soil layer across the fault zone.

In some possible implementations, the loading device 1 further includes a plurality of guide rails 12 and a plurality of sets of first hydraulic jacks 13. The plurality of guide rails 12 are arranged within the interval space 001. The plurality of guide rails 12 are distributed in one-to-one correspondence with the plurality of vertical stacking frames 21. An end of each of the plurality of vertical stacking frames 21 is arranged on a corresponding one of the plurality of guide rails 12. The plurality of sets of first hydraulic jacks 13 are distributed in one-to-one correspondence with the plurality of guide rails 12. Each of the plurality of sets of first hydraulic jacks 13 includes a plurality of first hydraulic jacks 13. The plurality of first hydraulic jacks 13 in each set are evenly spaced apart in a direction of a corresponding vertical stacking frame 21. Each of the two sets of horizontal stacking frames 31 includes a plurality of horizontal stacking frames 31. Each of the plurality of horizontal stacking frames 31 is in an open rectangular frame structure. The plurality of horizontal stacking frames 31 are arranged in a stacked manner. A first neoprene rubber pad adapted to any horizontal stacking frame 31 is provided between any two adjacent horizontal stacking frames 31.

Specifically, the guide rails are configured to support the vertical stacking frames and facilitate the sliding of the vertical stacking frames on the guide rails during a simulated dislocation. This design can reduce the friction when the vertical stacking frames slide on the guide rails, thereby enhancing the accuracy of a simulation test. The first hydraulic jacks are configured to support the guide rails, which in turn supports a soil filled in the model box. The horizontal stacking frames are designed as an open rectangular frame structure with one side missing. The first neoprene rubber pad is arranged between two adjacent horizontal stacking frames to enable a relative dislocation and slide between the two adjacent horizontal stacking frames during a dislocation process.

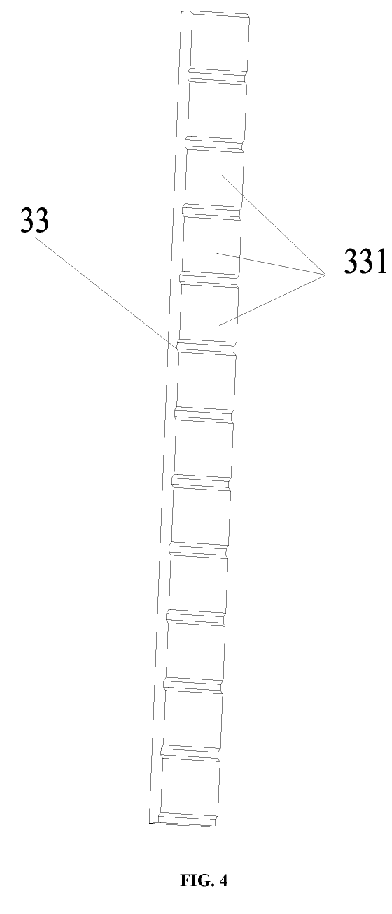

In some possible implementations, the horizontal simulation device further includes two sets of fixators 33. The two sets of fixators 33 are distributed in one-to-one correspondence with the two sets of horizontal stacking frames 31. Each of the two sets of fixators 33 is arranged at an end of the corresponding set of horizontal stacking frames 31 that is away from the interval space 001. Each of the two sets of fixators 33 includes two fixators 33. The two fixators 33 are spaced apart and arranged at the end of the corresponding set of horizontal stacking frames 31. Each fixator 33 is in a columnar structure. An end of each fixator 33 is fixed to the corresponding seismic fault testing device-loading platform 11. As shown in FIG. 4, each fixator 33 is provided with a plurality of smooth rails 331 in an axial direction of the fixator 33. The plurality of smooth rails 331 are distributed in one-to-one correspondence with a plurality of horizontal stacking frames 31 of a corresponding set of horizontal stacking frames 31. Each of the plurality of smooth rails abuts against a corresponding horizontal stacking frame 31 and is capable of sliding smoothly.

Specifically, the fixators are configured to fix the horizontal stacking frames in an X direction, which can prevent the horizontal stacking frames from slipping in the X-direction during a dislocation test to compromise the accuracy of simulation. Moreover, the smooth rails on the fixators can reduce the friction between the fixators and the horizontal stacking frames to enhance the accuracy of a simulation test.

In some possible implementations, each of the two sets of stacking blocks 32 includes a plurality of groups of first stacking blocks 321 and two groups of second stacking blocks 322. The plurality of groups of first stacking blocks 321 are arranged between the two groups of second stacking blocks 322. The plurality of groups of first stacking blocks 321 are distributed in one-to-one correspondence with the plurality of vertical stacking frames 21. Each of the plurality of groups of first stacking blocks 321 includes a plurality of first stacking blocks 321 that are adjacently stacked. A second neoprene rubber pad adapted to any first stacking block 321 is provided between any two adjacent first stacking blocks 321. Widths of each first stacking block 321 and each second stacking block 322 in a vertical direction are the same as a width of each horizontal stacking frame 31 in the vertical direction. Widths of each first stacking block 321 and each second stacking block 322 in a horizontal direction are the same as a width of each vertical stacking frame 21 in the horizontal direction. Each of the two groups of second stacking blocks 322 is distributed in one-to-one correspondence with a corresponding set of horizontal stacking frames 31. Each of the two groups of second stacking blocks 322 includes a plurality of second stacking blocks 322 that are adjacently stacked. Second stacking blocks 322 that are located at a same side and are adjacent to corresponding horizontal stacking frames 31 respectively abut against open ends of the corresponding horizontal stacking frames 31. A third neoprene rubber pad adapted to any second stacking block 322 is provided between any two adjacent second stacking blocks 322. A fourth neoprene rubber pad adapted to any second stacking block 322 is provided between any adjacent second stacking block 322 and horizontal stacking frame 31.

Specifically, the plurality of first stacking blocks are adjacently stacked to form a plane with an equal overall width to the plurality of vertical stacking frames and an equal overall height to the plurality of horizontal stacking frames. The plurality of second stacking blocks are adjacently stacked to create a plane that is located at left and right sides of the first stacking blocks, and has the same overall height as the plurality of horizontal stacking frames, but a smaller width than the steel support frames. Open ends of the horizontal stacking frames abut against the outermost second stacking block. The horizontal stacking frames, the vertical stacking frames, the first stacking blocks, the second stacking blocks, and the associated neoprene rubber pads form a closed rectangular stacked ring. The vertical stacking frames and the seismic fault testing device-loading platforms together create a closed rectangular space for the filling of a soil layer. The second neoprene rubber pad, the third neoprene rubber pad, and the fourth neoprene rubber pad are all provided to reduce friction, allowing a relative dislocation and slide between first stacking blocks, between second stacking blocks, and between a second stacking block and a horizontal stacking frame with the deformation of a soil layer.

In some possible implementations, the vertical simulation device 2 further includes two steel support frames 22. Each of the two steel support frames 22 is in an open rectangular frame structure. The two steel support frames 22 are fixed to the two seismic fault testing device-loading platforms 11 respectively. The two steel support frames 22 are arranged at two sides of the plurality of vertical stacking frames 21, respectively. An edge of one of the two steel support frames 22 abuts against an adjacent vertical stacking frame 21 at a side, and an edge of the other one of the two steel support frames 22 abuts against an adjacent vertical stacking frame 21 at another side. A fifth neoprene rubber pad adapted to any vertical stacking frame 21 is provided between any two adjacent vertical stacking frames 21. The vertical simulation device 2 further includes two sets of second hydraulic jacks 23. The two sets of second hydraulic jacks 23 are symmetrically arranged along a central axis of symmetry of the two sets of horizontal stacking frames 31. Each of the two sets of second hydraulic jacks 23 includes two groups of second hydraulic jacks 23. The two groups of second hydraulic jacks 23 are distributed in one-to-one correspondence with the two sets of horizontal stacking frames 31. Each of the two groups of second hydraulic jacks 23 includes a plurality of second hydraulic jacks 23. The plurality of second hydraulic jacks 23 in each group are distributed in one-to-one correspondence with a plurality of horizontal stacking frames 31 in a corresponding set of horizontal stacking frames 31. Two open ends of each horizontal stacking frame 31 in each set are located between two vertical inner side surfaces of an adjacent steel support frame 22. An end of each second hydraulic jack 23 is in contact with a corresponding horizontal stacking frame 31, and another end of the second hydraulic jack 23 is vertically fixed to two vertical inner side surfaces of an adjacent steel support frame 22. The vertical simulation device 2 further includes two sets of third hydraulic jacks 24. The two sets of third hydraulic jacks 24 are symmetrically arranged along the central axis of symmetry of the two sets of horizontal stacking frames 31. Each of the two sets of third hydraulic jacks 24 includes a plurality of groups of third hydraulic jacks 24. The plurality of groups of third hydraulic jacks 24 are distributed in one-to-one correspondence with the plurality of vertical stacking frames 21. Each of the plurality of groups of third hydraulic jacks 24 includes a plurality of third hydraulic jacks 24. The plurality of third hydraulic jacks 24 in each group are evenly spaced along a vertical inner side surface of a corresponding vertical stacking frame 21. An end of each third hydraulic jack 24 is fixedly connected to a corresponding vertical stacking frame 21. Each group of third hydraulic jacks 24 is distributed in one-to-one correspondence with each group of first stacking blocks 321. Another end of each third hydraulic jack 24 abuts against a corresponding first stacking block 321.

Specifically, the fifth neoprene rubber pad is configured to reduce friction to allow a relative dislocation and slide between vertical stacking frames with the deformation of a soil layer. The second hydraulic jack and the third hydraulic jack are both configured to simulate lateral boundary conditions of a soil to prevent interference with a dislocation test. Jacking forces of a second hydraulic jack and a third hydraulic jack are set to equal geostatic resultant stresses at depths of a soil layer corresponding to a horizontal stacking frame and a first stacking block, respectively, thereby restricting a lateral displacement of a soil. The third hydraulic jacks, the vertical stacking frames, and the corresponding first stacking blocks constitute an integrated unit. During a dislocation, the deformation of a soil layer causes this integrated unit composed of the third hydraulic jacks, the vertical stacking frames, and the corresponding first stacking blocks to slide in a Z-Y plane.

In some possible implementations, the vertical simulation device 2 further includes two sets of fourth hydraulic jacks 25. The two sets of fourth hydraulic jacks 25 are symmetrically arranged along the central axis of symmetry of the two sets of horizontal stacking frames 31. Each of the two sets of fourth hydraulic jacks 25 includes two groups of fourth hydraulic jacks 25. The two groups of fourth hydraulic jacks 25 are distributed in one-to-one correspondence with the two steel support frames 22. Each of the two groups of fourth hydraulic jacks 25 includes a plurality of fourth hydraulic jacks 25. The plurality of fourth hydraulic jacks 25 in each group are evenly spaced along a vertical inner side surface of a corresponding steel support frame 22. An end of each fourth hydraulic jack 25 is fixedly connected to a corresponding steel support frame 22. Each group of fourth hydraulic jacks 25 is distributed in one-to-one correspondence with each group of second stacking blocks 322. Another end of each fourth hydraulic jack 25 abuts against a corresponding second stacking block 322.

Specifically, the fourth hydraulic jacks are configured to simulate lateral boundary conditions of a soil during a dislocation test, thereby preventing interference with the dislocation test. A jacking force of a fourth hydraulic jack is set to equal a geostatic resultant stress at a depth of a soil layer corresponding to a second stacking block, so as to restrict a lateral displacement of a soil.

Embodiment 2

As shown in FIG. 1 to FIG. 3, Embodiment 2 of the present disclosure provides a use method of a model box for simulating a coseismic stick-slip dislocation. The use method is provided to use the model box for simulating a coseismic stick-slip dislocation in Embodiment 1. The use method includes: The model box for simulating the coseismic stick-slip dislocation is arranged. A model soil layer is filled inside the model box for simulating the coseismic stick-slip dislocation, such that a jacking force of each second hydraulic jack is equal to a geostatic resultant stress at a burial depth of the model soil layer corresponding to a horizontal stacking frame, a jacking force of each third hydraulic jack is equal to a geostatic resultant stress at a burial depth of the model soil layer corresponding to a first stacking block, a jacking force of each fourth hydraulic jack is equal to a geostatic resultant force at a burial depth of the model soil layer corresponding to a second stacking block, and a combined jacking force of each first hydraulic jack is equal to a gravity of the model soil layer corresponding to a depth where the model soil layer locates. The coseismic stick-slip dislocation is simulated with the two seismic fault testing device-loading platforms. Displacement change data is monitored for each vertical stacking frame, each first stacking block, each second stacking block, and each horizontal stacking frame. An internal deformation pattern of the model soil layer during a simulated coseismic stick-slip dislocation process is generated based on the displacement change data.

Specifically, the guide rails and the first hydraulic jacks are arranged in the interval space between the two seismic fault testing device-loading platforms, and the vertical stacking frames are then arranged. The steel support frames are fixed at two sides of the vertical stacking frames. The interval space serves as the main dislocation zone for a test. The steel support frames are configured to fix the vertical stacking frames in an X-direction, preventing the vertical stacking frames from sliding in the X-direction during a test to affect a test result. The guide rails are configured to support the vertical stacking frames and facilitate the sliding of the vertical stacking frames in a Y-direction during a test. Subsequently, the first stacking blocks and the second stacking blocks are arranged at inner sides of the vertical stacking frames. The vertical stacking frames are connected to the first stacking blocks through the third hydraulic jacks. The steel support frames are connected to the second stacking blocks through the fourth hydraulic jacks. An overall width of the vertical stacking frames arranged is equal to an overall width of the first stacking blocks arranged. A second neoprene rubber pad adapted to any first stacking block is provided between any two adjacent first stacking blocks. A third neoprene rubber pad adapted to any second stacking block is provided between any two adjacent second stacking blocks. A fifth neoprene rubber pad adapted to any vertical stacking frame is provided between any two adjacent vertical stacking frames. The horizontal stacking frames and the fixators are then arranged at two sides of the second stacking blocks. The horizontal stacking frames are connected to the steel support frames through the second hydraulic jacks, so as to complete the assembly of the model box for simulating a coseismic stick-slip dislocation. A first neoprene rubber pad adapted to any horizontal stacking frame is provided between any two adjacent horizontal stacking frames. A fourth neoprene rubber pad adapted to any second stacking block is provided between any adjacent second stacking block and horizontal stacking frame. The arrangement of the first neoprene rubber pad, the second neoprene rubber pad, the third neoprene rubber pad, and the fourth neoprene rubber pad allows a relative dislocation and slide between stacking blocks, between a stacking block and a horizontal stacking frame, and between a stacking block and a vertical stacking frame with the deformation of a soil layer during a test, which reduces the relative friction and enhance the testing

accuracy. After the assembly is completed, an overall height of the first stacking blocks and an overall height of the second stacking blocks are the same as a height of the horizontal stacking frames. During a test, depending on characteristics of a simulated soil layer, an accuracy of simulation, and a depth of the soil layer, dimensions of the horizontal stacking frames, the vertical stacking frames, the first stacking blocks, and the second stacking blocks can be adjusted with the respective assembly dimension requirements met. The higher the filled soil layer, the greater the stacking heights of the first stacking blocks, the second stacking blocks, and the horizontal stacking frames after the assembly. A jacking force of each second hydraulic jack is equal to a geostatic resultant stress at a burial depth of the model soil layer corresponding to a horizontal stacking frame. A jacking force of each third hydraulic jack is equal to a geostatic resultant stress at a burial depth of the model soil layer corresponding to a first stacking block. A jacking force of each fourth hydraulic jack is equal to a geostatic resultant force at a burial depth of the model soil layer corresponding to a second stacking block. The settings of the jacking forces of these three hydraulic jacks are adopted to simulate lateral boundary conditions of a soil. A combined jacking force of each first hydraulic jack is equal to a gravity of the model soil layer corresponding to a depth where the model soil layer locates, which aims to support a soil filled in the model box. Displacement changes of each vertical stacking frame, each first stacking block, each second stacking block, and each horizontal stacking frame can be monitored by displacement sensors provided for the vertical stacking frame, the first stacking block, the second stacking block, and the horizontal stacking frame, or can be recorded by high-definition cameras provided outside the model box.

It should be noted that the use method of a model box for simulating a coseismic stick-slip dislocation in Embodiment 2 is applied to the model box for simulating a coseismic stick-slip dislocation in Embodiment 1. Therefore, the performance principles of the model box for simulating a coseismic stick-slip dislocation are not repeated here, and the related details can refer to Embodiment 1.

The preferred specific embodiments of the present disclosure are described in detail above. It should be understood that a person of ordinary skill in the art can

make various modifications and variations according to the concept of the present disclosure without creative efforts. Therefore, all technical solutions that can be obtained by a person skilled in the art based on the prior art through logical analysis, reasoning, or finite experiments according to the concept of the present disclosure shall fall within the protection scope defined by the appended claims.

What is claimed is:

1. A model box for simulating a coseismic stick-slip dislocation, comprising:
a loading device (1) comprising two seismic fault testing device-loading platforms (11), wherein the two seismic fault testing device-loading platforms (11) are spaced apart and symmetrically arranged on a horizontal plane, and an interval space (001) is formed between the two seismic fault testing device-loading platforms (11);
a vertical simulation device (2) comprising a plurality of vertical stacking frames (21), wherein each of the plurality of vertical stacking frames (21) is in a rectangular frame structure, any adjacent two of the plurality of vertical stacking frames (21) are arranged in contact with each other, and an end of each of the plurality of vertical stacking frames (21) is vertically arranged within the interval space (001); and
a horizontal simulation device (3) comprising two sets of horizontal stacking frames (31) and two sets of stacking blocks (32), wherein each of the two sets of horizontal stacking frames (31) is in an open rectangular frame structure, the two sets of horizontal stacking frames (31) are symmetrically arranged on the two seismic fault testing device-loading platforms (11) with the interval space (001) as an axis of symmetry, and the two sets of horizontal stacking frames (31) are arranged at two sides of the plurality of vertical stacking frames (21), respectively; each of the two sets of stacking blocks (32) is arranged adjacent to the two sets of horizontal stacking frames (31), and each of the two sets of stacking blocks (32) is arranged between openings of the two sets of horizontal stacking frames (31); an opening of each of the two sets of horizontal stacking frames (31) has two open ends; and an end of each of the two sets of stacking blocks (32) abuts against one open end of an adjacent one of the two sets of horizontal stacking frames (31), and another end of the one of the two sets of stacking blocks (32) abuts against one open end of another adjacent one of the two sets of horizontal stacking frames (31).

2. The model box according to claim 1, wherein the loading device (1) further comprises:
a plurality of guide rails (12), wherein the plurality of guide rails (12) are arranged within the interval space (001), the plurality of guide rails (12) are distributed in one-to-one correspondence with the plurality of vertical stacking frames (21), and an end of each of the plurality of vertical stacking frames (21) is arranged on a corresponding one of the plurality of guide rails (12); and
a plurality of sets of first hydraulic jacks (13), wherein the plurality of sets of first hydraulic jacks (13) are distributed in one-to-one correspondence with the plurality of guide rails (12); and each set of the plurality of sets of first hydraulic jacks (13) comprises a plurality of first hydraulic jacks (13), and the plurality of first hydraulic jacks (13) in each set are evenly spaced apart in a direction of a corresponding vertical stacking frame (21).

3. The model box according to claim 2, wherein each set of the two sets of horizontal stacking frames (31) comprises a plurality of horizontal stacking frames (31); each of the plurality of horizontal stacking frames (31) is in an open rectangular frame structure; and the plurality of horizontal stacking frames (31) are arranged in a stacked manner, and a first neoprene rubber pad adapted to any one of the horizontal stacking frames (31) is provided between any adjacent two of the horizontal stacking frames (31).

4. The model box according to claim 3, wherein the horizontal simulation device (3) further comprises two sets of fixators (33); the two sets of fixators (33) are distributed in one-to-one correspondence with the two sets of horizontal stacking frames (31), and each set of the two sets of fixators (33) is arranged at an end of a corresponding set of horizontal stacking frames (31) that is away from the interval space (001); each set of the two sets of fixators (33) comprises two fixators (33), and the two fixators (33) are spaced apart and arranged at the end of the corresponding set of horizontal stacking frames (31); each of the fixators (33) is in a columnar structure, and an end of each fixator (33) is fixed to a corresponding seismic fault testing device-loading platform (11); each fixator (33) is provided with a plurality of smooth rails (331) in an axial direction of the fixator (33); and the plurality of smooth rails (331) are distributed in one-to-one correspondence with the plurality of horizontal stacking frames (31) of a corresponding set of horizontal stacking frames (31), and each of the plurality of smooth rails abuts against a corresponding horizontal stacking frame (31) and the corresponding horizontal stacking frame (31) is capable of sliding smoothly.

5. The model box according to claim 4, wherein each set of the two sets of stacking blocks (32) comprises a plurality of groups of first stacking blocks (321) and two groups of second stacking blocks (322); the plurality of groups of first stacking blocks (321) are arranged between the two groups of second stacking blocks (322); the plurality of groups of first stacking blocks (321) are distributed in one-to-one correspondence with the plurality of vertical stacking frames (21); each group of the plurality of groups of first stacking blocks (321) comprises a plurality of first stacking blocks (321) that are adjacently stacked; a second neoprene rubber pad adapted to any one of the first stacking blocks (321) is provided between any adjacent two of the first stacking blocks (321); and widths of each first stacking block (321) and each second stacking block (322) in a vertical direction are identical to a width of each horizontal stacking frame (31) in the vertical direction, and widths of each first stacking block (321) and each second stacking block (322) in a horizontal direction are identical to a width of each vertical stacking frame (21) in the horizontal direction.

6. The model box according to claim 5, wherein each group of the two groups of second stacking blocks (322) is distributed in one-to-one correspondence with each set of the two sets of horizontal stacking frames (31); each group of the two groups of second stacking blocks (322) comprises a plurality of second stacking blocks (322) that are adjacently stacked; the plurality of second stacking blocks (322) that are located at a same side and are adjacent to corresponding horizontal stacking frames (31) respectively abut against open ends of the corresponding horizontal stacking frames (31); a third neoprene rubber pad adapted to any one of the plurality of second stacking blocks (322) is provided between any adjacent two of the second stacking blocks (322); and a fourth neoprene rubber pad adapted to any one of the plurality of second stacking blocks (322) is provided between any adjacent second stacking block (322) and horizontal stacking frame (31).

7. The model box according to claim 6, wherein the vertical simulation device (2) further comprises:
two steel support frames (22), wherein each of the two steel support frames (22) is in an open rectangular frame structure; the two steel support frames (22) are fixed to the two seismic fault testing device-loading platforms (11), respectively, and the two steel support frames (22) are arranged at two sides of the plurality of vertical stacking frames (21), respectively; an edge of one of the two steel support frames (22) abuts against an adjacent vertical stacking frame (21) at a side, and an edge of the other one of the two steel support frames (22) abuts against another adjacent vertical stacking frame (21) at another side; and a fifth neoprene rubber pad adapted to any one of the plurality of vertical stacking frames (21) is provided between any adjacent two of the plurality of vertical stacking frames (21); and
two sets of second hydraulic jacks (23), wherein the two sets of second hydraulic jacks (23) are symmetrically arranged along a central axis of symmetry of the two sets of horizontal stacking frames (31); each set of the two sets of second hydraulic jacks (23) comprises two groups of second hydraulic jacks (23), and the two groups of second hydraulic jacks (23) are distributed in one-to-one correspondence with the two sets of horizontal stacking frames (31); each group of the two groups of second hydraulic jacks (23) comprises a plurality of second hydraulic jacks (23), and the plurality of second hydraulic jacks (23) in each group are distributed in one-to-one correspondence with the plurality of horizontal stacking frames (31) in a corresponding set of horizontal stacking frames (31); two open ends of each horizontal stacking frame (31) in each set are located between two vertical inner side surfaces of an adjacent steel support frame (22); and an end of each second hydraulic jack (23) is in contact with a corresponding horizontal stacking frame (31), and another end of the second hydraulic jack (23) is vertically fixed within two vertical inner side surfaces of an adjacent steel support frame (22).

8. The model box according to claim 7, wherein the vertical simulation device (2) further comprises two sets of third hydraulic jacks (24); the two sets of third hydraulic jacks (24) are symmetrically arranged along the central axis of symmetry of the two sets of horizontal stacking frames (31); each set of the two sets of third hydraulic jacks (24) comprises a plurality of groups of third hydraulic jacks (24), and the plurality of groups of third hydraulic jacks (24) are distributed in one-to-one correspondence with the plurality of vertical stacking frames (21); each group of the plurality of groups of third hydraulic jacks (24) comprises a plurality of third hydraulic jacks (24); the plurality of third hydraulic jacks (24) in each group are evenly spaced along a vertical inner side surface of a corresponding vertical stacking frame (21); an end of each third hydraulic jack (24) is fixedly connected to a corresponding vertical stacking frame (21); and
each group of third hydraulic jacks (24) is distributed in one-to-one correspondence with each group of first stacking blocks (321); and another end of each third hydraulic jack (24) abuts against a corresponding first stacking block (321).

9. The model box according to claim 8, wherein the vertical simulation device (2) further comprises two sets of fourth hydraulic jacks (25); the two sets of fourth hydraulic jacks (25) are symmetrically arranged along the central axis of symmetry of the two sets of horizontal stacking frames (31); each set of the two sets of fourth hydraulic jacks (25) comprises two groups of fourth hydraulic jacks (25), and the two groups of fourth hydraulic jacks (25) are distributed in one-to-one correspondence with the two steel support frames (22); each group of the two groups of fourth hydraulic jacks (25) comprises a plurality of fourth hydraulic jacks (25); the plurality of fourth hydraulic jacks (25) in each group are evenly spaced along a vertical inner side surface of a corresponding steel support frame (22); an end of each fourth hydraulic jack (25) is fixedly connected to a corresponding steel support frame (22); and
each group of fourth hydraulic jacks (25) is distributed in one-to-one correspondence with each group of second stacking blocks (322); and another end of each fourth hydraulic jack (25) abuts against a corresponding second stacking block (322).

10. A use method of the model box according to claim 1, comprising:
mounting the model box;
filling a model soil layer inside the model box, such that a jacking force of each second hydraulic jack is equal to a geostatic resultant stress at a burial depth of the model soil layer corresponding to a horizontal stacking frame, a jacking force of each third hydraulic jack is equal to a geostatic resultant stress at a burial depth of the model soil layer corresponding to a first stacking block, a jacking force of each fourth hydraulic jack is equal to a geostatic resultant force at a burial depth of the model soil layer corresponding to a second stacking block, and a combined jacking force of each first hydraulic jack is equal to a gravity of the model soil layer corresponding to a depth where the model soil layer locates; and
simulating the coseismic stick-slip dislocation with the two seismic fault testing device-loading platforms, monitoring displacement change data of each vertical stacking frame, each first stacking block, each second stacking block, and each horizontal stacking frame, and generating an internal deformation pattern of the model soil layer during a simulated coseismic stick-slip dislocation process based on the displacement change data.
